(19) United States
(12) Patent Application Publication
(10) Pub. No.: US 2026/0066547 A1
(43) Pub. Date: Mar. 5, 2026

(54) ANTENNA STRUCTURE AND COMMUNICATION DEVICE

(71) Applicant: HUAWEI TECHNOLOGIES CO., LTD., Shenzhen (CN)

(72) Inventors: Xin Feng, Chengdu (CN); Zheng Li, Beijing (CN); Yanping Duan, Beijing (CN); Zhongpo Jiang, Chengdu (CN); Ping Cao, Shenzhen (CN)

(73) Assignee: HUAWEI TECHNOLOGIES CO., LTD., Shenzhen (CN)

(21) Appl. No.: 19/381,245

(22) Filed: Nov. 6, 2025

Related U.S. Application Data
(63) Continuation of application No. PCT/CN2024/085057, filed on Mar. 29, 2024.

(30) Foreign Application Priority Data
May 6, 2023 (CN) 202310510036.3

(51) Int. Cl. H01Q 13/22; H01Q 3/24

(52) U.S. Cl. CPC H01Q 13/22; H01Q 3/24

(57) ABSTRACT

An antenna structure and a communication device. The antenna structure includes a feeding structure and a leaky-wave antenna. The leaky-wave antenna includes a rectangular waveguide and a radiating element, and the radiating element is located on any side wall of the rectangular waveguide. The radiating element includes slot elements, and a plurality of groups of slot elements are arranged at intervals in an extension direction of the rectangular waveguide. The slot element includes a first slot and a second slot, the first slot and the second slot are arranged with an included angle, and the first slot and the second slot are arranged at intervals in the extension direction of the rectangular waveguide. The leaky-wave antenna further includes a control component connected to the radiating element.

### CROSS-REFERENCE TO RELATED APPLICATIONS

This application is a continuation of International Application No. PCT/CN2024/085057, filed on Mar. 29, 2024, which claims priority to Chinese Patent Application No. 202310510036.3, filed on May 6, 2023. The disclosures of the aforementioned applications are hereby incorporated by reference in their entireties.

### TECHNICAL FIELD

The embodiments relate to the field of antenna technologies, and to an antenna structure and a communication device.

### BACKGROUND

An antenna is an important part of a modern communication system, and is configured to radiate and receive electromagnetic energy. As society continuously raises requirements for the communication system, a gain, a beam sweeping capability, and a plurality of operating modes of the antenna attract much attention. Compared with other types of antennas, a leaky-wave antenna naturally has characteristics of high directivity, a low profile, and beam sweeping with frequency. In addition, with rapid development of communication technologies, a simple fixed-beam antenna can hardly meet a system requirement, and construction of an antenna with a fixed-frequency beam sweeping function becomes significant.

As shown in FIG. 1, a metallic waveguide-based orthogonal mode dual-polarized leaky-wave antenna 10 includes a feeding part 11 and a radiating part 12. The feeding part 11 may operate as a dual-polarized feed supply (an orthogonal mode sensor), and the radiating part 12 is configured to transmit electromagnetic energy. The feeding part 11 includes a first rectangular waveguide 13, a second rectangular waveguide 14, a square waveguide 15, and a converter 16. The first rectangular waveguide 13 and the second rectangular waveguide 14 have different cross-sectional sizes, and are respectively configured to excite electromagnetic signals in two orthogonal modes: TE 10 and TE 01. The radiating part 12 includes a slot antenna 17 and a radiating pyramid 18. The orthogonal mode dual-polarized leaky-wave antenna 10 can implement a dual-polarization function, but can radiate electromagnetic energy only at the radiating pyramid 18, and cannot implement fixed-frequency beam sweeping. To resolve the foregoing problem, in a related technology, an active phased array antenna 20 is used to implement dual-polarized fixed-frequency beam sweeping. As shown in FIG. 2, the active phased array antenna 20 includes 256 electronic components 21 and 64 silicon chips 22, and these silicon chips 22 are configured to feed dual-polarized 2×2 antennas. Active components such as a transmitter and receiver module (transmitter and receiver, T/R) component and a phase shifter are connected to a back end of an antenna array. A phase of the antenna is adjusted via the phase shifter, and electromagnetic interference superposition is used to cause the 2×2 antennas to perform beam combination in space, so as to implement spatial dual-polarized fixed-frequency beam sweeping.

However, a large quantity of T/R components are used in the active phased array antenna, resulting in a complex system, high costs, and high system power consumption.

### SUMMARY

Embodiments provide an antenna structure and a communication device. The antenna structure can implement dual-polarized fixed-frequency beam sweeping, and has a simple structure, a low profile, and low costs.

A first aspect of embodiments provides an antenna structure. The antenna structure includes a feeding structure and a leaky-wave antenna. The leaky-wave antenna includes a rectangular waveguide and a radiating element, and the radiating element is located on any side wall of the rectangular waveguide. The radiating element includes slot elements, and a plurality of groups of slot elements are arranged at intervals in an extension direction of the rectangular waveguide. The slot element includes a first slot and a second slot, and the first slot and the second slot are arranged with an included angle, and the first slot and the second slot are arranged at intervals in the extension direction of the rectangular waveguide. The leaky-wave antenna further includes a control component, the control component is connected to the radiating element, and the control component is configured to control the first slot and the second slot to be open-circuited or short-circuited. The feeding structure is arranged at an end of the rectangular waveguide, and the feeding structure is configured to feed electromagnetic signals in two mutually orthogonal modes into the rectangular waveguide.

In the antenna structure provided in embodiments, the feeding structure is arranged, so that the electromagnetic signals may be fed into the leaky-wave antenna via the feeding structure, and the leaky-wave antenna can radiate the electromagnetic signals to the outside. The electromagnetic signals in two mutually orthogonal modes are fed into the leaky-wave antenna, and the radiating element is set to include the first slot and the second slot, so that the leaky-wave antenna can implement dual-polarized fixed-frequency beam radiation. The control component is configured to control the first slot and the second slot to be open-circuited or short-circuited, so that operation statuses of the first slot and the second slot are further controlled. For example, when the first slot or the second slot is short-circuited, the first slot or the second slot is in a non-operating state; or when the first slot or the second slot is open-circuited, the first slot or the second slot is in an operating state. The operation statuses of the first slot and the second slot are controlled, so that beam sweeping of the leaky-wave antenna is implemented. The antenna structure not only has advantages of a simple structure of the leaky-wave antenna, a low profile, and low costs, but also can implement a fixed-frequency beam sweeping function, so that performance of the antenna structure can be greatly improved, and an application scenario of the antenna structure can be extended.

In a possible embodiment, the first slot and the second slot are perpendicular to each other.

The first slot and the second slot are arranged perpendicular to each other, so that the antenna structure can generate two orthogonal polarized waves, and two signals are orthogonal to each other and therefore do not affect each other. In this way, one antenna structure can be arranged in a duplex operating mode of receiving and transmitting, to reuse the antenna structure, thereby improving a communication capacity, and reducing a quantity of antennas mounted in a communication device, so as to reduce costs.

In a possible embodiment, one of the first slot and the second slot is arranged in the extension direction of the rectangular waveguide, and the other one of the first slot and the second slot is arranged perpendicular to the extension direction of the rectangular waveguide.

One of the first slot and the second slot is arranged in the extension direction of the rectangular waveguide, and the other is arranged perpendicular to the extension direction of the rectangular waveguide, so that a gain of the antenna structure can be increased, and antenna performance can be improved.

In a possible embodiment, a slow-wave structure is arranged in the rectangular waveguide, where the slow-wave structure is configured to convert the electromagnetic signals, fed by the feeding structure into the rectangular waveguide, into target electromagnetic signals having a slow-wave transmission characteristic.

The slow-wave structure is arranged in the rectangular waveguide, so that the electromagnetic signals fed into the rectangular waveguide can be converted into the target electromagnetic signals having the slow-wave transmission characteristic, to improve bandwidth, the gain, power, and the like of the antenna structure.

In a possible embodiment, the slow-wave structure includes cruciform structures and connecting segments, where a plurality of cruciform structures are arranged at intervals in a perpendicular direction of a plane on which the cruciform structures are located; and the connecting segment is arranged between two adjacent cruciform structures, and the connecting segment is configured to fasten the two adjacent cruciform structures.

The slow-wave structure is set to include the cruciform structures and the connecting segments, and the cruciform structure can block the electromagnetic signals in two mutually orthogonal modes, so that the electromagnetic signals can be reflected, diffracted, or the like between the rectangular waveguide and the slow-wave structure, and the electromagnetic signals in two mutually orthogonal modes are both converted into the target electromagnetic signals having the slow-wave transmission characteristic. The connecting segments are arranged, so that the plurality of cruciform structures can be connected. This can facilitate arrangement of the slow-wave structure in the rectangular waveguide.

In a possible embodiment, the slow-wave structure is arranged in the extension direction of the rectangular waveguide, and the plane on which the cruciform structures are located is perpendicular to the extension direction of the rectangular waveguide.

The slow-wave structure is arranged in the extension direction of the rectangular waveguide, and the plane on which the cruciform structures are located is perpendicular to the extension direction of the rectangular waveguide, so that each cruciform structure on the slow-wave structure can be arranged opposite to an end part of the rectangular waveguide. In this way, a projection area of the cruciform structure on an end surface of the rectangular waveguide can be ensured to be the largest, thereby achieving a better blocking effect, improving utilization of the slow-wave structure, improving efficiency, and reducing a volume and costs compared with an incline arrangement.

In a possible embodiment, the cruciform structure includes a first extension arm and a second extension arm, where the first extension arm and the second extension arm are perpendicular to each other, and a geometric center of the first extension arm coincides with a geometric center of the second extension arm.

The first extension arm and the second extension arm of the cruciform structure are perpendicular to each other, and the geometric center of the first extension arm coincides with the geometric center of the second extension arm, so that the cruciform structure can be a centrosymmetric structure, and the slow-wave structure can be a centrosymmetric structure. Because reflection of electromagnetic signals in all directions by the centrosymmetric structure in the rectangular waveguide is more uniform, radiation of the antenna structure in different directions can be more uniform, and the antenna performance is improved.

In a possible embodiment, one of the first extension arm and the second extension arm is perpendicular to a plane on which the radiating element is located.

One of the first extension arm and the second extension arm is arranged to be perpendicular to the plane on which the radiating element is located, so that the projection area of the cruciform structure on the end surface of the rectangular waveguide can be the largest, thereby achieving a better blocking effect, improving utilization of the slow-wave structure, improving efficiency, and reducing a volume and costs compared with the incline arrangement.

In a possible embodiment, geometric centers of all the cruciform structures on the slow-wave structure are located on a same straight line.

The geometric centers of all the cruciform structures on the slow-wave structure are arranged on the same straight line, so that a plurality of connecting segments of the slow-wave structure can be located on the same straight line. This facilitates processing of the slow-wave structure, thereby reducing processing costs.

In a possible embodiment, sizes of cruciform structures closer to two ends of the slow-wave structure are smaller than a size of a cruciform structure closer to a middle part of the slow-wave structure.

In a possible embodiment, sizes of the cruciform structures gradually increase from the two ends of the slow-wave structure to the middle part of the slow-wave structure.

Sizes of cruciform structures at the two ends of the slow-wave structure are designed to be small, so that after the electromagnetic signals enter the rectangular waveguide, most signals can be prevented from being reflected back, and more electromagnetic signals are ensured to be transmitted inside the rectangular waveguide, thereby improving the gain, the power, and the like of the antenna structure, and improving the performance of the antenna structure.

In a possible embodiment, the plurality of cruciform structures and the connecting segments are connected to form a cross-shaped ridge structure.

The slow-wave structure is arranged as the cross-shaped ridge structure, so that slow-wave processing can be performed on the electromagnetic signals in two mutually orthogonal modes, and this facilitates mounting.

In a possible embodiment, the leaky-wave antenna includes a circuit board, where the circuit board is one side wall of the rectangular waveguide, and the radiating element is arranged on the circuit board.

The circuit board is arranged, so that a mounting position can be provided for the radiating element, to facilitate arrangement of the radiating element.

In a possible embodiment, the circuit board includes a first dielectric layer and a metal layer, where the first dielectric layer and the metal layer are arranged in a stacked manner, one surface of the first dielectric layer faces an inner cavity of the rectangular waveguide, and the other surface of the first dielectric layer is connected to the metal layer; and the radiating element is arranged on the metal layer.

In a possible embodiment, the control component is arranged on the first dielectric layer.

The first dielectric layer is arranged, so that a mounting position can be set for the control component, to facilitate arrangement of the control component. The metal layer is arranged, and this can facilitate arrangement of the radiating element.

In a possible embodiment, the leaky-wave antenna further includes a primary radiation structure, where the primary radiation structure and the metal layer are arranged in a stacked manner, and the radiation structure is located on a surface that is of the metal layer and that is away from the first dielectric layer.

The primary radiation structure is arranged. In this way, in an uplink direction, dual-polarized electromagnetic signals radiated to the outside by the radiating element can be amplified and then radiated, so that a gain of the antenna structure can be increased; and in a downlink direction, external electromagnetic signals can be collected and then enter the radiating element, so that sensitivity of the antenna structure can be improved.

In a possible embodiment, the primary radiation structure includes a plurality of metal patches, where each group of slot elements corresponds to one metal patch.

The primary radiation element is arranged as the plurality of metal patches. Because the metal patch has a simple structure, this facilitates arrangement, and can reduce costs. Each slot element corresponds to one metal patch, so that dual-polarized electromagnetic signals radiated by each slot element can both be amplified. In this way, the gain of the antenna can be increased.

In a possible embodiment, the circuit board further includes a second dielectric layer, where the second dielectric layer is located on the surface that is of the metal layer and that is away from the first dielectric layer, and the primary radiation structure is located on a surface that is of the second dielectric layer and that is away from the metal layer.

The second dielectric layer is arranged, so that the radiating element and the primary radiation structure can be insulated from each other, to prevent electromagnetic interference between the radiating element and the primary radiation structure.

In a possible embodiment, a semi-cured layer is arranged between the metal layer and the second dielectric layer.

In a possible embodiment, the control component includes a plurality of first switches and a plurality of second switches, where the plurality of first switches are configured to control a plurality of first slots to be open-circuited or short-circuited, and the plurality of second switches are configured to control a plurality of second slots to be open-circuited or short-circuited.

The control component is set to be of a structure including the first switches and the second switches, so that the control component can separately control operation statuses of the first slots and the second slots, and the antenna structure can implement beam sweeping.

In a possible embodiment, the antenna structure further includes a control unit, the control unit is connected to the control component, and the control unit is configured to control the plurality of first switches and the plurality of second switches in the control component to be turned on or turned off.

The control unit is arranged to facilitate controlling of the first switches and the second switches, and further control the antenna structure to implement a beam sweeping function. In this way, the antenna structure can implement beam sweeping at different angles.

In a possible embodiment, the leaky-wave antenna includes a plurality of rectangular waveguides, where the plurality of rectangular waveguides are arranged in parallel in an extension direction perpendicular to the rectangular waveguides, and two adjacent rectangular waveguides share one side wall; and one radiating element is arranged on each rectangular waveguide, each radiating element is perpendicular to the side wall shared by the two adjacent rectangular waveguides, and radiating elements on different rectangular waveguides are all located on a same surface of the leaky-wave antenna.

The plurality of rectangular waveguides are arranged. This can increase the gain and the power of the antenna, and increase a coverage area of sweeping angles of the antenna, so that the antenna structure is applicable to more scenarios.

In a possible embodiment, the slot elements on two adjacent radiating elements are arranged in an interlaced manner.

The slot elements on the two adjacent radiating elements are arranged in the interlaced manner, so that mutual interference between radiating elements corresponding to two adjacent rectangular waveguides can be avoided, and the slot elements are distributed at more locations of the antenna structure, thereby improving a coverage area of the antenna structure, ensuring that gains of the antenna structure at different angles are all large, and improving the antenna performance.

In a possible embodiment, a distance between two groups of adjacent slot elements on a same radiating element is a first distance, and first distances between two groups of adjacent slot elements are all equal.

Distances between two groups of adjacent slot elements on the same radiating element are designed to be all the same, so that the antenna structure can perform even radiation and reception in different positions and in different directions, thereby improving pattern performance of the antenna and increasing the gain of the antenna.

In a possible embodiment, an interlacing distance between the slot elements on the two adjacent radiating elements is a second distance, and the first distance is 1.5 to 2 times the second distance.

In a possible embodiment, an interlacing distance between the slot elements on the two adjacent radiating elements is a second distance, and the first distance is twice the second distance.

The first distance is set to be twice the second distance, so that the gain and radiation efficiency of the antenna can be increased.

In a possible embodiment, the feeding structure includes a housing and an inner cavity structure, where the inner cavity structure has an input port arranged at one end and an output port arranged at the other end, and the input port communicates with the output port; and the output port is connected to the end of the rectangular waveguide, and the output port communicates with the inner cavity of the rectangular waveguide.

The output port of the feeding structure communicates with the inner cavity of the rectangular waveguide, so that the feeding structure can feed electromagnetic signals into the rectangular waveguide.

In a possible embodiment, the feeding structure further includes a retaining wall, where the retaining wall is arranged in the inner cavity structure, and the retaining wall is located at the end that is of the inner cavity and that is closer to the output port; two ends of the retaining wall are separately connected to the housing, and at least one retaining wall divides the output port into a plurality of sub output ports; and each of the sub output ports corresponds to one rectangular waveguide, and the retaining wall is opposite to the side wall shared by the two adjacent rectangular waveguides.

The retaining wall is arranged, and the at least one retaining wall divides the output port into the plurality of sub output ports, so that the electromagnetic signals in two mutually orthogonal modes can be fed into the plurality of rectangular waveguides by using one feeding structure.

In a possible embodiment, the electromagnetic signals in two mutually orthogonal modes include a TE10 mode electromagnetic signal and a TE01 mode electromagnetic signal.

In a possible embodiment, the retaining wall is a conical retaining wall, and a surface that is of the retaining wall and that is closer to the input port is a small end.

The retaining wall is arranged as a conical retaining wall, and the surface that is of the retaining wall and that is closer to the input port is the small end. In this way, reflection of the TE10 mode electromagnetic signal by the retaining wall can be reduced, and the TE10 mode electromagnetic signal is evenly distributed to the plurality of rectangular waveguides, so that the TE10 mode electromagnetic signal smoothly enters different rectangular waveguides, thereby improving power of the TE10 mode electromagnetic signal entering the rectangular waveguides, and improving the performance of the antenna structure.

In a possible embodiment, sloped walls are arranged in the inner cavity of the feeding structure, where two sloped walls are respectively arranged on two sides of the retaining wall, and the sloped walls gradually expand outwards from the input port to the output port.

The sloped walls are arranged in the inner cavity of the feeding structure, and the sloped walls gradually expand outwards from the input port to the output port. In this way, after entering the feeding structure, the TE01 mode electromagnetic signal can smoothly enter different rectangular waveguides, thereby increasing power of the TE01 mode electromagnetic signal entering the rectangular waveguides, and improving the performance of the antenna structure.

In a possible embodiment, both the first slot and the second slot are I-shaped slots.

Both the first slot and the second slot are designed as I-shaped slots, so that the gain of the antenna structure can be increased. In addition, the lengths of the first slot and the second slot can be adjusted, to cause the electromagnetic signals in two mutually orthogonal modes to have similar gains.

A second aspect of embodiments provides a communication device, including the antenna structure according to the first aspect.

Through arrangement of the antenna structure in the first aspect, the communication device not only has a simple structure and low costs, but also can implement a duplex operating mode. In addition, dual-polarized fixed-frequency beam sweeping can be implemented, thereby greatly improving performance of the communication device.

### BRIEF DESCRIPTION OF DRAWINGS

FIG. 1 is a diagram of a structure of a leaky-wave antenna;

FIG. 2 is a diagram of a structure of an active phased array antenna;

FIG. 3 is a diagram of a structure of an antenna structure according to an embodiment;

FIG. 4A is a diagram of an exploded structure of the structure shown in FIG. 3;

FIG. 4B is a diagram of an exploded structure of the structure shown in FIG. 3 from another angle;

FIG. 5 is a diagram of a partial structure of a primary radiation structure of an antenna structure according to an embodiment;

FIG. 6 is a diagram of a structure of a metal patch in a primary radiation structure of an antenna structure according to an embodiment;

FIG. 7 is a diagram of a partial structure of a radiating element of an antenna structure according to an embodiment;

FIG. 8 is a diagram of a structure of a slot element in a radiating element of an antenna structure according to an embodiment;

FIG. 9 is a diagram of a profile structure of a leaky-wave antenna of an antenna structure according to an embodiment;

FIG. 10 is a diagram of a structure of a control component of an antenna structure according to an embodiment;

FIG. 11 is a diagram of a structure of a first switch and a second switch in a control component of an antenna structure according to an embodiment;

FIG. 12 shows gain curves when a sweeping periodicity length of an antenna structure is 4.75p₀ according to an embodiment;

FIG. 13 shows gain curves when a sweeping periodicity length of an antenna structure is 5p₀ according to an embodiment;

FIG. 14 shows gain curves when a sweeping periodicity length of an antenna structure is 6p₀ according to an embodiment;

FIG. 15 shows gain curves when a sweeping periodicity length of an antenna structure is 7p₀ according to an embodiment;

FIG. 16 shows gain curves when a sweeping periodicity length of an antenna structure is 9p₀ according to an embodiment;

FIG. 17 shows gain curves when a sweeping periodicity length of an antenna structure is 12p₀ according to an embodiment;

FIG. 18 shows an example of a simulation result of a perpendicular polarization radiation pattern of an antenna structure according to an embodiment;

FIG. 19 shows an example of a simulation result of a horizontal polarization radiation pattern of an antenna structure according to an embodiment;

FIG. 20 is a diagram of a structure of a slow-wave structure of an antenna structure according to an embodiment;

FIG. 21 is a diagram of a profile structure of a feeding structure of an antenna structure according to an embodiment; and

FIG. 22 is an S-parameter diagram of a feeding structure of an antenna structure according to an embodiment.

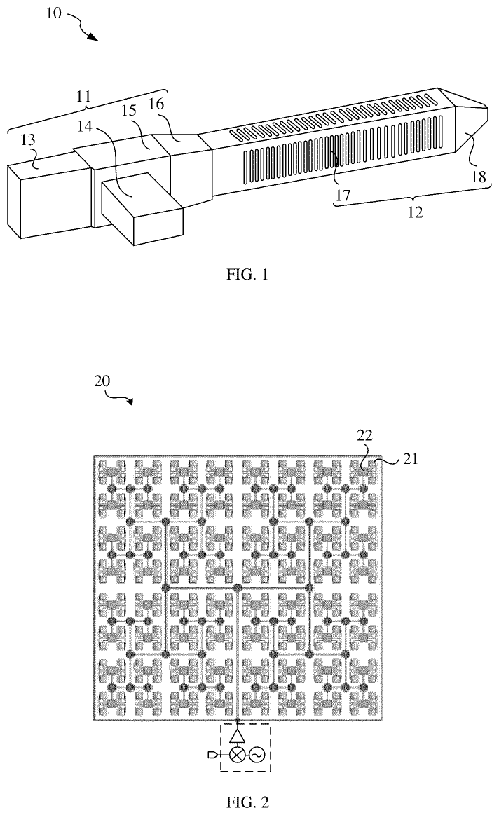

### DETAILED DESCRIPTION OF EMBODIMENTS

Terms used in embodiments are merely used to explain specific embodiments, and are not intended as limiting.

Unless otherwise required in the context, throughout the embodiments, the term “include (comprise)” and other forms of the term, for example, a third person singular form “includes (comprises)” and a present participle form “including (comprising)”, are interpreted as “open and inclusive”, namely, “include but not limited to”. In description of the embodiments, terms such as “one embodiment (one embodiment)”, “some embodiments (some embodiments)”, “exemplary embodiments (exemplary embodiments)”, “example (example)”, or “some examples (some examples)” are intended to indicate that a particular feature, structure, material, or characteristic related to the embodiment or example is included in at least one embodiment or example. The foregoing example representations of the terms do not necessarily refer to a same embodiment or example. Further, the particular feature, structure, material, or characteristic may be included in any one or more embodiments or examples in any appropriate manner.

Moreover, in the embodiments, position terms such as “front” and “back” are defined relative to example placement positions of components in the accompanying drawings. It should be understood that these direction terms are relative concepts and are used for relative description and clarification, and may accordingly change based on a change of the placement positions of the components in the accompanying drawings.

The term “and/or” in embodiments describe only an association relationship for describing associated objects and represents that three relationships may exist. For example, A and/or B may represent the following three cases: only A exists, both A and B exist, and only B exists. In addition, the character “/” generally indicates an “or” relationship between the associated objects.

In an application scenario of mobile communication, an antenna system is required to have a beam sweeping function, and an operation band is fixed. This means that a frequency sweeping characteristic of a conventional leaky-wave antenna is not applicable to this case. Therefore, a leaky-wave antenna that can perform beam sweeping under a condition of fixed frequency becomes an important research direction of the leaky-wave antenna.

For a leaky-wave antenna with fixed-frequency beam sweeping, a currently used beam sweeping manner includes loading a PIN diode having a switching effect, using a phase shifter, a ferrite tuning material, a capacitive diode, a micro-electro-mechanical (micro-electro-mechanical system, MEMS) switch, a liquid crystal material, and the like. In addition, in the related technology, only a single polarization manner can be implemented, and dual-polarized radiation cannot be implemented. If a fixed-frequency beam sweeping leaky-wave antenna with dual-polarized radiation performance can be implemented, a function of this type of antenna can be greatly improved, an application field of this type of antenna can be extended, and a use value of this type of antenna can be increased.

Embodiments provide an antenna structure and a communication device. The antenna structure can implement dual-polarized fixed-frequency beam sweeping, has a strong anti-interference capability, and also has at least an advantage of improving a channel capacity.

The antenna structure and the communication device provided in embodiments may be applicable to various communication systems. For example, the communication system may be a long term evolution (LTE) system, a 5th generation (5th Generation, 5G for short) communication system, a 6th generation (6G) communication system, a global system for mobile communications (GSM a code division multiple access (CDMA system, a wideband code division multiple access (WCDMA) system, a general packet radio service (GPRS system, an LTE time division duplex (TDD) system, a universal mobile telecommunications system (UMTS), or a worldwide interoperability for microwave access (WiMAX) communication system. Also, the antenna structure and the communication device in embodiments may alternatively be applicable to another communication system. This is not limited herein.

The communication device provided in the embodiments may be a base station. The base station may be a device configured to communicate with a terminal device, and includes a base transceiver station (BTS) in a global system for mobile communications (GSM) or code division multiple access (CDMA), may be a NodeB (NB) in a wideband code division multiple access (WCDMA) system, may be an evolved NodeB (eNB or eNodeB) in an LTE system, or may be a radio controller in a cloud radio access network (cloud radio access network, CRAN) scenario. Alternatively, the base station may include a relay station, an access point, a vehicle-mounted device, a wearable device, a base station in a future 5G network, a base station in a future evolved public land mobile communication network (PLMN) network, or the like. This is not limited.

The communication device provided in embodiments includes the antenna structure in the first aspect. A main component for information transmission between the base station and a mobile device is the antenna structure. Through arrangement of the antenna structure in the first aspect, the communication device not only has a simple structure and low costs, but also can implement a duplex operating mode. In addition, dual-polarized fixed-frequency beam sweeping can be implemented, thereby greatly improving performance of the communication device.

The following describes in detail the antenna structure provided in the first aspect of embodiments with reference to the accompanying drawings.

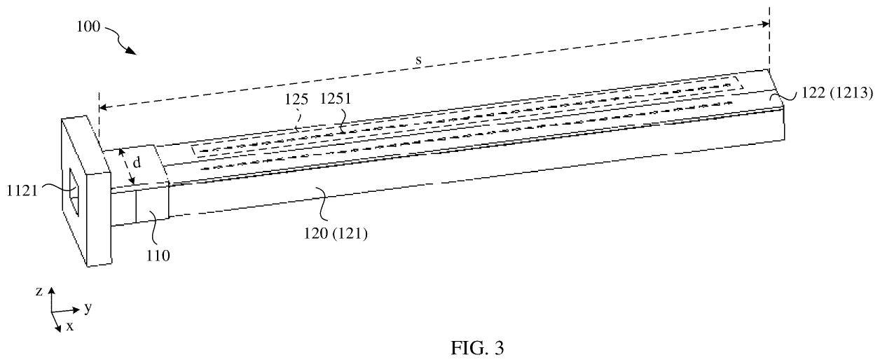

An embodiment provides an antenna structure 100. As shown in FIG. 3, the antenna structure 100 includes a leaky-wave antenna 120 and a feeding structure 110. The feeding structure 110 is fixedly arranged at an end of the leaky-wave antenna 120, and the feeding structure 110 is configured to feed electromagnetic signals into the leaky-wave antenna 120, so that the leaky-wave antenna 120 can receive or transmit the electromagnetic signals.

For example, the feeding structure 110 may feed electromagnetic signals in two mutually orthogonal modes into the leaky-wave antenna 120. For example, the electromagnetic signals in two mutually orthogonal modes include a TE10 mode electromagnetic signal and a TE01 mode electromagnetic signal. The feeding structure 110 may feed the TE10 mode electromagnetic signal and the TE01 mode electromagnetic signal into the leaky-wave antenna 120. Also, in another embodiment, electromagnetic signals in other two mutually orthogonal modes may alternatively be fed. In embodiments, modes of signals fed by the feeding structure 110 into the leaky-wave antenna 120 are not further limited, provided that the modes are mutually orthogonal.

For ease of description, in this embodiment, a direction from a rectangular waveguide 121 to a radiating element 123 is used as a height direction of the antenna structure 100, and is represented as a z direction in the figure; an extension direction of the rectangular waveguide 121 is used as a length direction of the antenna structure 100, and is represented as a y direction in the figure; and a width direction of the rectangular waveguide 121 is used as a width direction of the antenna structure 100, and is represented as an x direction in the figure.

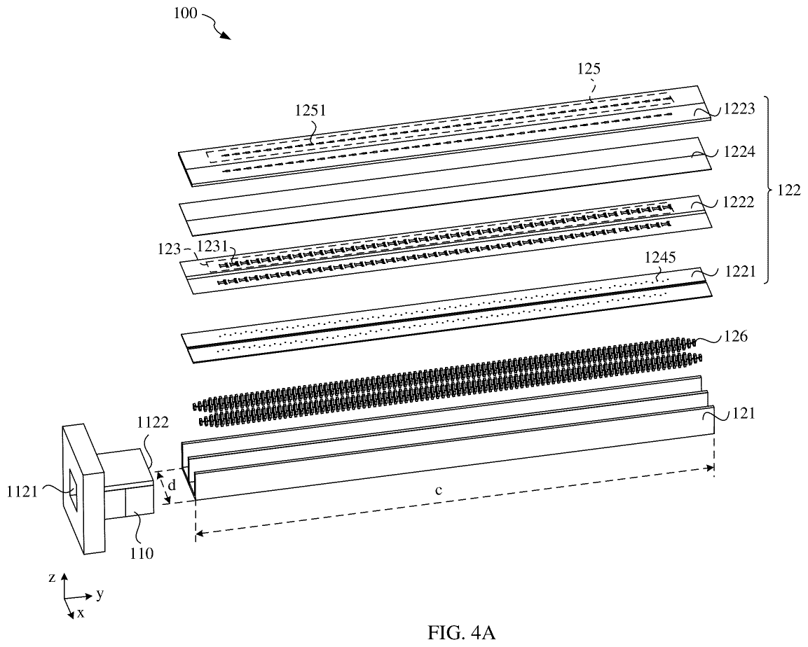

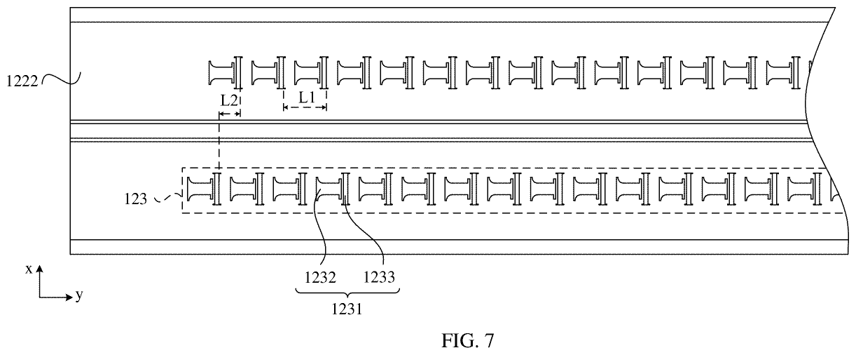

Still refer to FIG. 3. The leaky-wave antenna 120 may include the rectangular waveguide 121 and the radiating element 123 (as shown in FIG. 4A), where the radiating element 123 is located on any side wall of the rectangular waveguide 121. As shown in FIG. 4A, the radiating element 123 may include slot elements 1231, and a plurality of groups of slot elements 1231 are arranged at intervals in the extension direction of the rectangular waveguide 121. The slot element 1231 may include a first slot 1232 and a second slot 1233 (as shown in FIG. 7), and the first slot 1232 and the second slot 1233 are arranged with an included angle, and the first slot 1232 and the second slot 1233 are arranged at intervals in the extension direction of the rectangular waveguide 121. The leaky-wave antenna 120 may further include a control component 124 (as shown in FIG. 4A), where the control component 124 is connected to the radiating element 123, and the control component 124 is configured to control the first slot 1232 and the second slot 1233 to be open-circuited or short-circuited.

In the antenna structure 100 provided in embodiments, the feeding structure 110 is arranged, so that the electromagnetic signals may be fed into the leaky-wave antenna 120 via the feeding structure 110, and the leaky-wave antenna 120 can radiate the electromagnetic signals to the outside. The electromagnetic signals in two mutually orthogonal modes are fed into the leaky-wave antenna 120, and the radiating element 123 is set to include the first slot 1232 and the second slot 1233, so that the leaky-wave antenna 120 can implement dual-polarized fixed-frequency beam radiation.

The control component 124 is configured to control the first slot 1232 and the second slot 1233 to be open-circuited or short-circuited, so that operation statuses of the first slot 1232 and the second slot 1233 are further controlled. For example, when the first slot 1232 or the second slot 1233 is short-circuited, the first slot 1232 or the second slot 1233 is in a non-operating state; or when the first slot 1232 or the second slot 1233 is open-circuited, the first slot 1232 or the second slot 1233 is in an operating state. The operation statuses of the first slot 1232 and the second slot 1233 are controlled, so that beam sweeping of the leaky-wave antenna 120 is implemented.

The antenna structure 100 not only has advantages of the simple structure 100 of the leaky-wave antenna 120, a low profile, and low costs, but also can implement a fixed-frequency beam sweeping function, so that performance of the antenna structure 100 can be greatly improved, and an application scenario of the antenna structure 100 can be extended.

For example, for ease of description, in this embodiment, as shown in FIG. 4B, side walls of the rectangular waveguide 121 may be classified into a first side wall 1211, a second side wall 1212, a third side wall 1213, and a fourth side wall 1214. The first side wall 1211 and the second side wall 1212 are arranged opposite to each other in the x direction, and the third side wall 1213 and the fourth side wall 1214 are arranged opposite to each other in the z direction. In addition, two end parts of the first side wall 1211 in the z direction are respectively connected to the third side wall 1213 and the fourth side wall 1214, and two ends of the second side wall 1212 in the z direction are respectively connected to the third side wall 1213 and the fourth side wall 1214. In this way, a cavity structure with a rectangular cross section is formed among the third side wall 1213, the first side wall 1211, the fourth side wall 1214, and the second side wall 1212.

The feeding structure 110 is arranged at an end of the rectangular waveguide 121 in the y direction. In other words, the feeding structure 110 is arranged at an end of the cavity structure, so that the feeding structure 110 can feed electromagnetic signals into the rectangular waveguide 121 from the end of the cavity structure.

It should be noted that, in some embodiments, the electromagnetic signal may also be referred to as a signal, electromagnetic energy, or the like.

For example, the radiating element 123 may be arranged on one of the first side wall 1211, the second side wall 1212, the third side wall 1213, or the fourth side wall 1214 of the rectangular waveguide 121. For example, the radiating element 123 is arranged on the third side wall 1213 of the rectangular waveguide 121. Also, in another embodiment, the radiating element 123 may alternatively be arranged on another position of the rectangular waveguide 121. An arrangement position of the radiating element 123 is not further limited. The following uses an example in which the radiating element 123 is arranged on the third side wall 1213 of the rectangular waveguide 121 for description.

In this embodiment, the leaky-wave antenna 120 may include a circuit board 122, where the circuit board 122 is one side wall of the rectangular waveguide 121, and the radiating element 123 is arranged on the circuit board 122. The circuit board 122 is arranged, so that a mounting position can be provided for the radiating element 123, to facilitate arrangement of the radiating element 123. For example, the third side wall 1213 of the rectangular waveguide 121 may be the circuit board 122, and the radiating element 123 is arranged on the third side wall 1213 of the rectangular waveguide 121.

Still refer to FIG. 4A. The circuit board 122 may include a first dielectric layer 1221, a metal layer 1222, a semi-cured layer 1224, and a second dielectric layer 1223. For example, the first dielectric layer 1221, the metal layer 1222, the semi-cured layer 1224, and the second dielectric layer 1223 are sequentially arranged in a stacked manner, one surface of the first dielectric layer 1221 faces an inner cavity of the rectangular waveguide 121, and the other surface of the first dielectric layer 1221 is connected to the metal layer 1222. The radiating element 123 may be arranged on the metal layer 1222. For example, the slot elements 1231 of the radiating element 123 may be provided on the metal layer 1222.

In some embodiments, the control component 124 may be arranged on the first dielectric layer 1221. For example, a partial structure of the control component 124 may be arranged on the surface that is of the first dielectric layer 1221 and that is closer to the inner cavity of the rectangular waveguide 121, and the partial structure of the control component 124 may pass through the first dielectric layer 1221 to connect to the radiating element 123. The first dielectric layer 1221 is arranged, so that a mounting position can be set for the control component 124, to facilitate arrangement of the control component 124. The metal layer 1222 is arranged, and this can facilitate arrangement of the radiating element 123.

In this embodiment, the second dielectric layer 1223 is located on a surface that is of the metal layer 1222 and that is away from the first dielectric layer 1221. The semi-cured layer 1224 may be further arranged between the metal layer 1222 and the second dielectric layer 1223. The semi-cured layer 1224 can insulate the metal layer 1222 from the second dielectric layer 1223, and can also increase strength of the circuit board 122, so that the circuit board 122 is not distorted after being heated.

In some embodiments, the leaky-wave antenna 120 may further include a primary radiation structure 125. The primary radiation structure 125 and the metal layer 1222 are arranged in a stacked manner, and the radiation structure is located on the surface that is of the metal layer 1222 and that is away from the first dielectric layer 1221. For example, the primary radiation structure 125 may be arranged on a surface that is of the second dielectric layer 1223 and that is away from the metal layer 1222.

The primary radiation structure 125 is arranged. In this way, in an uplink direction, dual-polarized electromagnetic signals radiated to the outside by the radiating element 123 can be amplified and then radiated, so that a gain of the antenna structure 100 can be increased; and in a downlink direction, external electromagnetic signals can be collected and then enter the radiating element 123, so that sensitivity of the antenna structure 100 can be improved. The second dielectric layer 1223 is arranged, so that the radiating element 123 and the primary radiation structure 125 can be insulated from each other, to prevent electromagnetic interference between the radiating element 123 and the primary radiation structure 125.

In some embodiments, materials of both the first dielectric layer 1221 and the second dielectric layer 1223 may be RO4350B, where RO4350B is a material of a hydrocarbon resin system/ceramic packing that is enhanced by using woven glass fabric. Also, in another embodiment, the materials of the first dielectric layer 1221 and the second dielectric layer 1223 may alternatively be other materials. In embodiments, the materials of the first dielectric layer 1221 and the second dielectric layer 1223 are not further limited.

In some embodiments, the thicknesses of both the first dielectric layer 1221 and the second dielectric layer 1223 may be 0.254 mm. Also, in another embodiment, the thicknesses of the first dielectric layer 1221 and the second dielectric layer 1223 may alternatively be other values. For example, the thicknesses of the first dielectric layer 1221 and the second dielectric layer 1223 may be any value from 0.2 mm to 0.3 mm, for example, 0.22 mm, 0.25 mm, or 0.28 mm. In embodiments, the thicknesses of the first dielectric layer 1221 and the second dielectric layer 1223 are not further limited.

In some embodiments, the thickness of the metal layer 1222 may be 0.035 mm. Also, in another embodiment, the thickness of the metal layer 1222 may alternatively be another value. For example, the thickness of the metal layer 1222 may be any value from 0.02 mm to 0.04 mm, for example, 0.02 mm, 0.03 mm, or 0.04 mm. In embodiments, the thickness of the metal layer 1222 is not further limited.

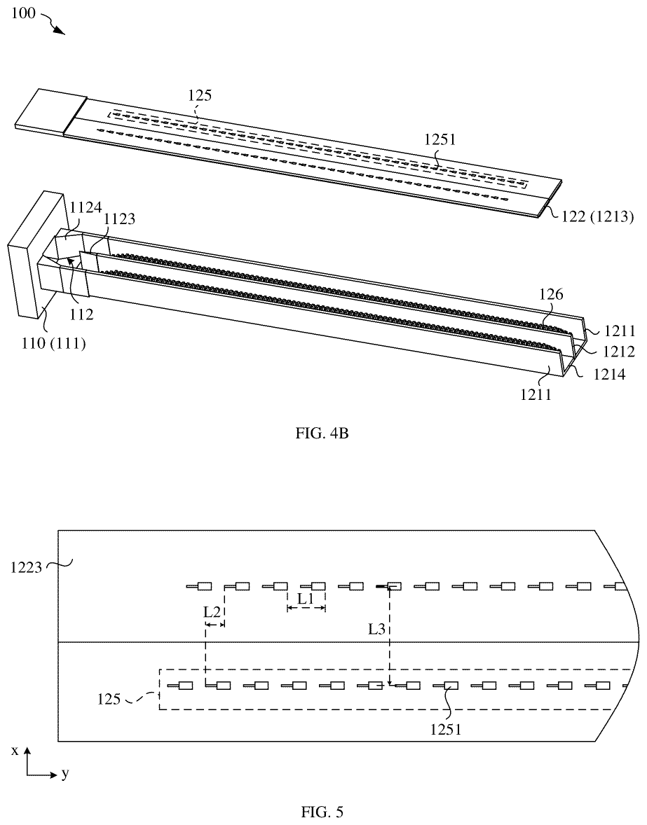

In some embodiments, as shown in FIG. 5, the primary radiation structure 125 may include a plurality of metal patches 1251. The plurality of metal patches 1251 are arranged at intervals in the y direction, and each group of slot elements 1231 corresponds to one metal patch 1251.

The primary radiation element 123 is arranged as the plurality of metal patches 1251. Because the metal patch 1251 has a simple structure, this facilitates arrangement, and can reduce costs. Each slot element 1231 corresponds to one metal patch 1251, so that dual-polarized electromagnetic signals radiated by each slot element 1231 can both be amplified. In this way, the gain of the antenna can be increased.

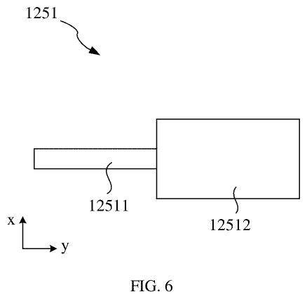

As shown in FIG. 6, the metal patch 1251 includes a first extension part 12511 and a second extension part 12512. The width of the first extension part 12511 in the x direction is smaller than the width of the second extension part 12512 in the x direction. For example, the first extension part 12511 corresponds to the first slot 1232, and the first extension part 12511 is configured to amplify an electromagnetic signal radiated by the first slot 1232. The second extension part 12512 corresponds to the second slot 1233, and the second extension part 12512 is configured to amplify an electromagnetic signal radiated by the second slot 1233. Also, in another embodiment, the metal patch 1251 may alternatively be of another structure. In embodiments, a specific shape of the metal patch 1251 is not further limited.

In some embodiments, the circuit board 122 may be formed by press-fitting the first dielectric layer 1221, the metal layer 1222, the semi-cured layer 1224, and the second dielectric layer 1223. Also, in another embodiment, the circuit board 122 may alternatively be formed in another manner. In embodiments, a forming process of the circuit board 122 is not further limited.

It should be noted that the leaky-wave antenna 120 may include a plurality of rectangular waveguides 121. For example, a quantity of rectangular waveguides 121 may be one, two, three, four, five, or more. When the quantity of rectangular waveguides 121 is plural, the plurality of rectangular waveguides 121 may be arranged in parallel in an extension direction perpendicular to the rectangular waveguides 121, and two adjacent rectangular waveguides 121 share one side wall. One radiating element 123 is arranged on each rectangular waveguide 121, each radiating element 123 is perpendicular to the side wall shared by the two adjacent rectangular waveguides 121, and radiating elements 123 on different rectangular waveguides 121 are all located on a same surface of the leaky-wave antenna 120.

The plurality of rectangular waveguides 121 are arranged. This can increase the gain and the power of the antenna, and increase a coverage area of sweeping angles of the antenna, so that the antenna structure 100 is applicable to more scenarios.

In this embodiment, an example in which the antenna structure 100 has two rectangular waveguides 121 is used for description.

As shown in FIG. 7, the first slot 1232 and the second slot 1233 may be perpendicular to each other. For example, one of the first slot 1232 and the second slot 1233 is arranged in the extension direction (the y direction) of the rectangular waveguide 121, and the other one of the first slot 1232 and the second slot 1233 is arranged (in the x direction) perpendicular to the extension direction of the rectangular waveguide 121. For example, the first slot 1232 is arranged in the y direction, and the second slot 1233 is arranged in the x direction.

The first slot 1232 and the second slot 1233 are arranged perpendicular to each other, so that the antenna structure 100 can generate two orthogonal polarized waves, and two signals are orthogonal to each other and therefore do not affect each other. In this way, one antenna structure 100 can be arranged in a duplex operating mode of receiving and transmitting, to reuse the antenna structure 100, thereby improving a communication capacity, and reducing a quantity of antennas mounted in a communication device, so as to reduce costs.

One of the first slot 1232 and the second slot 1233 is arranged in the extension direction of the rectangular waveguide 121, and the other is arranged perpendicular to the extension direction of the rectangular waveguide 121, so that a gain of the antenna structure 100 can be increased, and antenna performance can be improved.

In this embodiment, a distance between two groups of adjacent slot elements 1231 on a same radiating element 123 is a first distance L1, and first distances L1 between two groups of adjacent slot elements 1231 are equal. In other words, a plurality of slot elements 1231 are evenly arranged.

Distances between two groups of adjacent slot elements 1231 on the same radiating element are designed to be all the same, so that the antenna structure 100 can perform even radiation and reception in different positions and in different directions, thereby improving pattern performance of the antenna and increasing the gain of the antenna.

In a possible embodiment, the slot elements 1231 on two adjacent radiating elements 123 (two radiating elements 123 that are adjacent in the x direction) are arranged in an interlaced manner.

The slot elements 1231 on the two adjacent radiating elements 123 are arranged in the interlaced manner, so that mutual interference between radiating elements 123 corresponding to two adjacent rectangular waveguides 121 can be avoided, and the slot elements 1231 are distributed at more locations of the antenna structure 100, thereby improving a coverage area of the antenna structure 100, ensuring that gains of the antenna structure 100 at different angles are all large, and improving the antenna performance.

For example, an interlacing distance between the slot elements 1231 on the two adjacent radiating elements 123 is a second distance L2, and the first distance L1 is twice the second distance L2. The first distance L1 is set to be twice the second distance L2, so that the gain and radiation efficiency of the antenna can be increased.

In some embodiments, the first distance L1 may be 3 mm, and the second distance L2 may be 1.5 mm. Also, in another embodiment, the first distance L1 and the second distance L2 may alternatively be other values. For example, the second distance L2 may be any value from 1 mm to 2 mm, and the first distance L1 is twice the second distance L2.

Additionally, in another embodiment, a quantitative relation between the first distance L1 and the second distance L2 may alternatively be another quantitative relation. For example, the first distance L1 is any value from 1.5 times to 2.5 times longer than the second distance L2. In embodiments, specific values of the first distance L1 and the second distance L2 and the quantitative relation between the first distance L1 and the second distance L2 are not further limited.

It should be noted that the foregoing interlacing distance is a distance between two slot elements 1231 of a same ranking on two adjacent radiating elements 123, for example, may be a distance between 1st slot elements 1231 on the two adjacent radiating elements 123.

In this embodiment, as the metal patch 1251 of the primary radiation structure 125 corresponds to the slot element 1231, a distance between two adjacent metal patches 1251 located on a same primary radiation structure 125 may also be a first distance L1, and an interlacing distance between metal patches 1251 on two adjacent primary radiation structures 125 may also be a second distance L2, where the first distance L1 is twice the second distance L2.

In addition, in some embodiments, a distance L3 between two adjacent primary radiation structures 125 in the x direction may be greater than or equal to 8 mm. In this way, interference between the two adjacent primary radiation structures 125 can be reduced, and a gain of the antenna structure 100 can be increased. Also, in another embodiment, the distance between the two adjacent primary radiation structures 125 in the x direction may alternatively be another value. In embodiments, the distance L3 between the two adjacent primary radiation structures 125 in the x direction is not further limited.

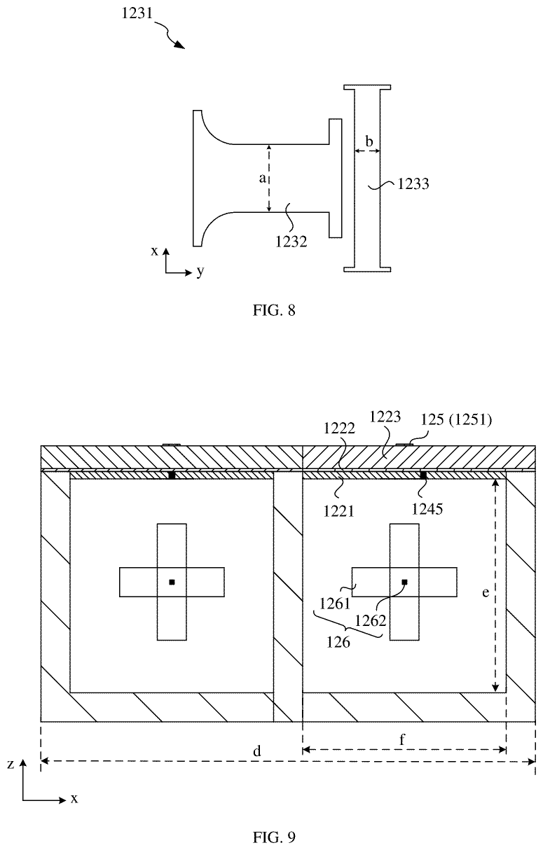

As shown in FIG. 8, both the first slot 1232 and the second slot 1233 may be I-shaped slots. Both the first slot 1232 and the second slot 1233 are designed as I-shaped slots, so that the gain of the antenna structure 100 can be increased. In addition, the lengths of the first slot 1232 and the second slot 1233 can be adjusted, to cause the electromagnetic signals in two mutually orthogonal modes to have similar gains.

During use, the first slot 1232 may be used as a vertical slot, and the second slot 1233 may be used as a horizontal slot. For example, the first slot 1232 allows a TE01 mode electromagnetic signal to leak to the outside, and the first slot 1232 may be used to radiate a horizontal polarized wave; and the second slot 1233 allows a TE10 mode electromagnetic signal to leak to the outside, and the second slot 1233 may be used to radiate a vertical polarized wave.

Also, in another embodiment, the first slot 1232 may alternatively be arranged in the x direction, and the second slot 1233 may alternatively be arranged in the y direction. In embodiments, directions in which the first slot 1232 and the second slot 1233 are arranged, and directions of polarized waves respectively radiated by the first slot 1232 and the second slot 1233 are not further limited.

As shown in FIG. 8, spacing a of the first slot 1232 in the y direction is greater than spacing b of the second slot 1233 in the y direction. In other words, the width a of the first slot 1232 is greater than the width b of the second slot 1233. As the horizontal polarized wave is parallel to the ground, partial energy is coupled to the ground, and consequently, radiation energy of the horizontal polarized wave is reduced. In this case, the width a of the first slot 1232 is set to be greater than the width b of the second slot 1233, so that the radiation energy of the horizontal polarized wave can be improved, to cause radiation energy of the vertical polarized wave to be well consistent with the radiation energy of the horizontal polarized wave.

In embodiments, specific values of the widths of the first slot 1232 and the second slot 1233 are not further limited, and may be set based on a specific situation.

In a possible embodiment, the antenna structure 100 includes the leaky-wave antenna 120 and the feeding structure 110. The leaky-wave antenna 120 may include two rectangular waveguides 121. For example, the total width d of the antenna structure 100 in the x direction may be 17 mm, and the length s of the antenna structure 100 in the y direction may be 163 mm, where the length s of the antenna structure 100 in the y direction refers to the total length of the leaky-wave antenna 120 and a partial structure that is of the feeding structure 110 and that has a same size as a leaky-wave antenna cross section. An operating frequency of the antenna structure 100 may be 24.25 GHz to 27.5 GHz, and a polarization characteristic is orthogonal dual polarization (vertical polarization and horizontal polarization).

Still refer to FIG. 3. A size of the leaky-wave antenna 120 may be 17 mm×148 mm. For example, the length c of the leaky-wave antenna 120 in the y direction may be 148 mm, and the length d of the leaky-wave antenna 120 in the x direction may be 17 mm.

As shown in FIG. 9, a size of the inner cavity of the rectangular waveguide 121 is 7 mm×7.6 mm, where the height e of the inner cavity of the rectangular waveguide 121 in the z direction is 7.6 mm, and the length f of the inner cavity of the rectangular waveguide 121 in the x direction is 7 mm. The size of the inner cavity of the rectangular waveguide 121 is set to 7 mm×7.6 mm, so that interference of an electromagnetic signal in another mode to the TE10 mode electromagnetic signal and the TE01 mode electromagnetic signal can be reduced.

Further, in another embodiment, the length of the antenna structure 100, the size of the leaky-wave antenna 120, and the size of the inner cavity of the rectangular waveguide 121 may all be set to other values. In embodiments, neither the size of the leaky-wave antenna 120 nor the size of the inner cavity of the rectangular waveguide 121 is further limited.

For example, in this embodiment, 43 groups of slot elements 1231 are all arranged on a radiating element 123 corresponding to each rectangular waveguide 121, two rectangular radiating elements 123 of two rectangular waveguides 121 include 86 groups of slot elements 1231 in total (two rows in total, with 43 groups in each row), and each group of slot elements 1231 includes a first slot 1232 and a second slot 1233 that are orthogonal to each other.

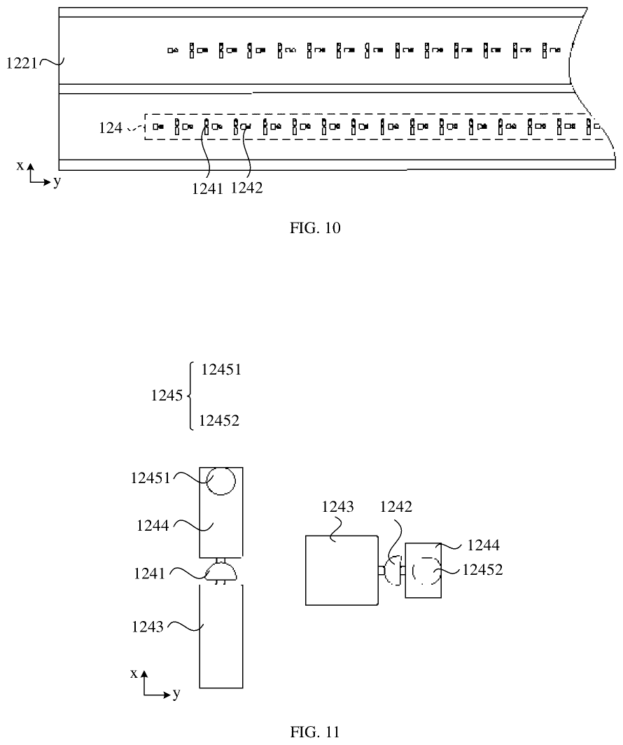

As shown in FIG. 10, in a possible embodiment, the control component 124 may include a plurality of first switches 1241 and a plurality of second switches 1242, where the plurality of first switches 1241 are configured to control a plurality of first slots 1232 to be open-circuited or short-circuited, and the plurality of second switches 1242 are configured to control a plurality of second slots 1233 to be open-circuited or short-circuited.

The control component 124 is set to be of a structure including the first switches 1241 and the second switches 1242, so that the control component 124 can separately control operation statuses of the first slots 1232 and the second slots 1233, and the antenna structure 100 can implement beam sweeping.

For example, both the first switches 1241 and the second switches 1242 may be PIN diodes or the like. Also, in another embodiment, the first switches 1241 and the second switches 1242 may alternatively be of other switch structures. In embodiments, specific structures of the first switches 1241 and the second switches 1242 are not further limited.

In addition, the control component 124 may further include metal columns 1245. Each first switch 1241 corresponds to one metal column 1245, and each second switch 1242 also corresponds to one metal column 1245. For ease of description, in this embodiment, the metal column 1245 corresponding to the first switch 1241 is used as a first metal column 12451, and the metal column 1245 corresponding to the second switch 1242 is used as a second metal column 12452.

For example, one end of the first metal column 12451 is electrically connected to the first switch 1241, and the other end is electrically connected to the first slot 1232. When the first switch 1241 is turned on, the first slot 1232 is in a short-circuit state, and in this case, the first slot 1232 stops operation and stops radiating an electromagnetic signal to the outside; or when the first switch 1241 is turned off, the first slot 1232 is in an open-circuit state, and in this case, the first slot 1232 operates and can radiate an electromagnetic signal to the outside.

One end of the second metal column 12452 is electrically connected to the second switch 1242, and the other end is electrically connected to the second slot 1233. When the second switch 1242 is turned on, the second slot 1233 is in a short-circuit state, and in this case, the second slot 1233 stops operation and stops radiating an electromagnetic signal to the outside; or when the second switch 1242 is turned off, the second slot 1233 is in an open-circuit state, and in this case, the second slot 1233 operates and can radiate an electromagnetic signal to the outside.

In some embodiments, the first switch 1241, the second switch 1242, and a solder pad soldering the first switch 1241 and the second switch 1242 may all be arranged on a surface that is of the first dielectric layer 1221 and that is away from the metal layer 1222. In this way, soldering difficulty can be reduced, and costs can be reduced.

The first switch 1241 and the second switch 1242 may be fastened on the first dielectric layer 1221 in a soldering manner. For example, as shown in FIG. 11, the solder pad may include a positive solder pad 1243 and a negative solder pad 1244.

For example, a positive solder pad 1243 and a negative solder pad 1244 as a group are respectively arranged at two ends of each first switch 1241. The positive solder pad 1243 and the negative solder pad 1244 are arranged opposite to each other, and there is spacing between the positive solder pad 1243 and the negative solder pad 1244. The first switch 1241 is arranged in the spacing between the positive solder pad 1243 and the negative solder pad 1244. The positive solder pad 1243 is electrically connected to the first switch 1241, and the negative solder pad 1244 is also electrically connected to the first switch 1241. The end that is of the first metal column 12451 and that is closer to the first switch 1241 may be electrically connected to the positive solder pad 1243 or the negative solder pad 1244.

When the first switch 1241 turned on, there is a closed circuit between a first solder pad and a second solder pad, and the first slot 1232 is in the short-circuit state. In this case, the first slot 1232 stops operation and stops radiating the electromagnetic signal to the outside. When the first switch 1241 is turned off, there is an open circuit between the first solder pad and the second solder pad, and the first slot 1232 is in the open-circuit state. In this case, the first slot 1232 operates and can radiate the electromagnetic signal to the outside.

For example, a positive solder pad 1243 and a negative solder pad 1244 as a group are respectively arranged at two ends of each second switch 1242. The positive solder pad 1243 and the negative solder pad 1244 are arranged opposite to each other, and there is spacing between the positive solder pad 1243 and the negative solder pad 1244. The second switch 1242 is arranged in the spacing between the positive solder pad 1243 and the negative solder pad 1244. The positive solder pad 1243 is electrically connected to the second switch 1242, and the negative solder pad 1244 is also electrically connected to the second switch 1242. The end that is of the second metal column 12452 and that is closer to the second switch 1242 may be electrically connected to the positive solder pad 1243 or the negative solder pad 1244.

When the second switch 1242 is turned on, there is a closed circuit between the first solder pad and the second solder pad, and the second slot 1233 is in the short-circuit state. In this case, the second slot 1233 stops operation and stops radiating the electromagnetic signal to the outside. When the second switch 1242 is turned off, there is an open circuit between the first solder pad and the second solder pad, and the second slot 1233 is in the open-circuit state. In this case, the second slot 1233 operates and can radiate the electromagnetic signal to the outside.

In the antenna structure 100 in this embodiment, control switches are arranged, so that different operation statuses of the slot element 1231 on the radiating element 123 are controlled, to implement a beam sweeping function of the antenna structure 100.

In a possible embodiment, the antenna structure 100 may further include a control unit, the control unit is connected to the control component 124, and the control unit is configured to control the plurality of first switches 1241 and the plurality of second switches 1242 in the control component 124 to be turned on or turned off.

The control unit is arranged, to facilitate controlling of the first switches 1241 and the second switches 1242, and further control the antenna structure 100 to implement the beam sweeping function. In this way, the antenna structure 100 can implement beam sweeping at different angles. For example, the control unit may be a field-programmable gate array (FPGA). Also, in another embodiment, the control unit may alternatively be another apparatus. In embodiments, a specific structure of the control unit is not further limited.

For ease of description, on states of the first switch 1241 and the second switch 1242 may both be defined as “0”, and off states of the first switch 1241 and the second switch 1242 may both be defined as “1”. The control unit periodically controls operation statuses of different first switches 1241 and second switches 1242, so that sweeping of the antenna structure 100 in different directions can be implemented.

The following uses an example in which the antenna structure 100 includes two rectangular waveguides 121 for description. An interlacing periodicity of slot elements 1231 on radiating elements 123 corresponding to two adjacent rectangular waveguides 121 is the second distance L2, and may be represented by p₀ in the figure. In some embodiments, p₀ may be 1.5 mm. Also, in another embodiment, p₀ may alternatively be another value, for example, 1.4 mm, 1.6 mm, or 1.7 mm. In embodiments, a specific value of p₀ is not further limited.

For example, a sweeping periodicity length of the antenna structure 100 may be represented by P. Table 1 shows 0/1 states corresponding to six periodicity lengths. For details, refer to Table 1.

TABLE 1

| Periodicity length | 0/1 states of first switches and second switches |
|---|---|
| P = 4.75p₀ | 110001100010000100011000110001000010001100011000100001000 |
| P = 5p₀ | 111001110011100111001110011100111001110011100111001110011 |
| P = 6p₀ | 111000111000111000111000111000111000111000111000111000111 |
| P = 7p₀ | 111000011100001110000111000011100001110000111000011100001 |
| P = 9p₀ | 111100000111100000111100000111100000111100000111100000111 |
| P = 12p₀ | 111111000000111111000000111111000000111111000000111111000 |

It should be noted that a sequence corresponding to the 0/1 states in Table 1 is an arrangement sequence of the first slots 1232 and the second slots 1233 from one end to the other end of the leaky-wave antenna 120, for example, an arrangement sequence of the first slots 1232 and the second slots 1233 from the left end to the right end in the figure. When the leaky-wave antenna 120 includes one rectangular waveguide 121, the sequence corresponding to the 0/1 states in Table 1 is an arrangement sequence of first slots 1232 and second slots 1233 from one end to the other end of radiating elements 123 corresponding to the leaky-wave antenna 120. When the leaky-wave antenna 120 includes a plurality of rectangular waveguides 121, the sequence corresponding to the 0/1 states in Table 1 is an arrangement sequence of the first slots 1232 and the second slots 1233 from one end to the other end of the leaky-wave antenna 120, for example, an arrangement sequence of first slots 1232 and second slots 1233 from the left end to the right end of the plurality of radiating elements 123 in the figure.

It should be noted that the table records only states of first switches 1241 and second switches 1242 on partial slot elements 1231. As states of the control component 124 periodically change, the table shows only a partial periodicity.

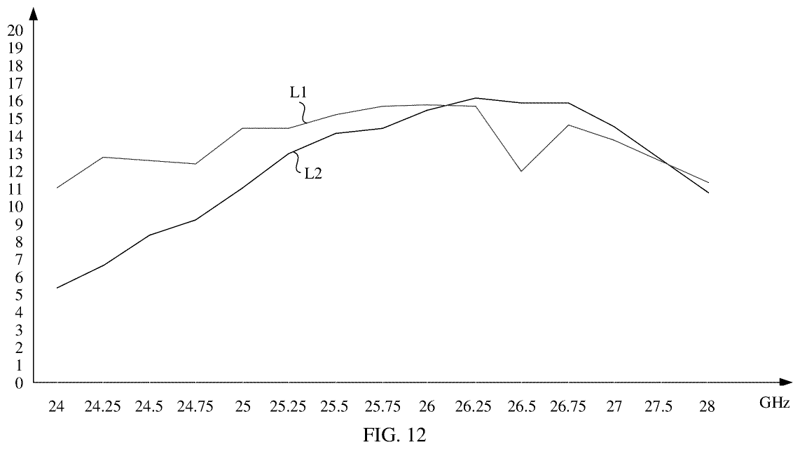

In an entire sweeping range, two groups of codes are separately selected near a forward direction, a backward direction, and a normal direction, to obtain results of six groups of antenna gains. FIG. 12 shows gain curves of a TE10 mode electromagnetic signal and a TE01 mode electromagnetic signal when a sweeping periodicity length is 4.75p₀. As shown in FIG. 12, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is −23°, and a sweeping angle of the TE01 mode electromagnetic signal is −29°. As shown in FIG. 12, when the sweeping periodicity length is 4.75p₀, on a low band, a difference between gains of the TE10 mode electromagnetic signal and the TE01 mode electromagnetic signal is large.

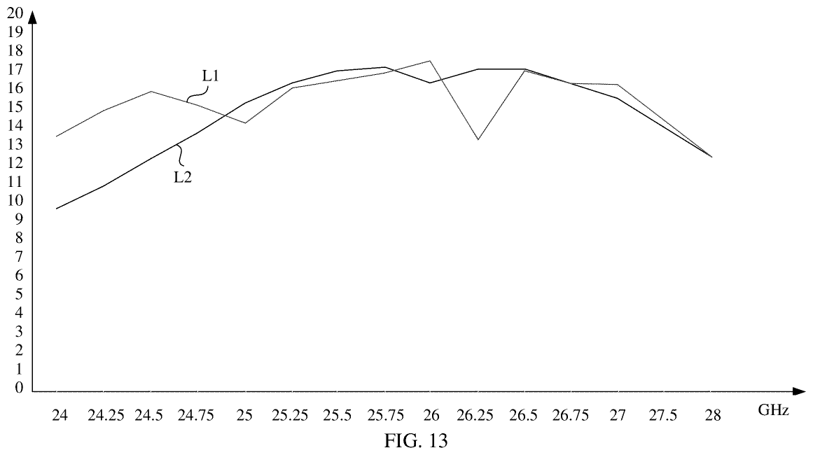

FIG. 13 shows gain curves of a TE10 mode electromagnetic signal and a TE01 mode electromagnetic signal when a sweeping periodicity length is 5p₀. As shown in FIG. 13, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is −18°, and a sweeping angle of the TE01 mode electromagnetic signal is −23°. As shown in FIG. 13, when the sweeping periodicity length is 5p₀, on a low band, a difference between gains of the TE10 mode electromagnetic signal and the TE01 mode electromagnetic signal is large.

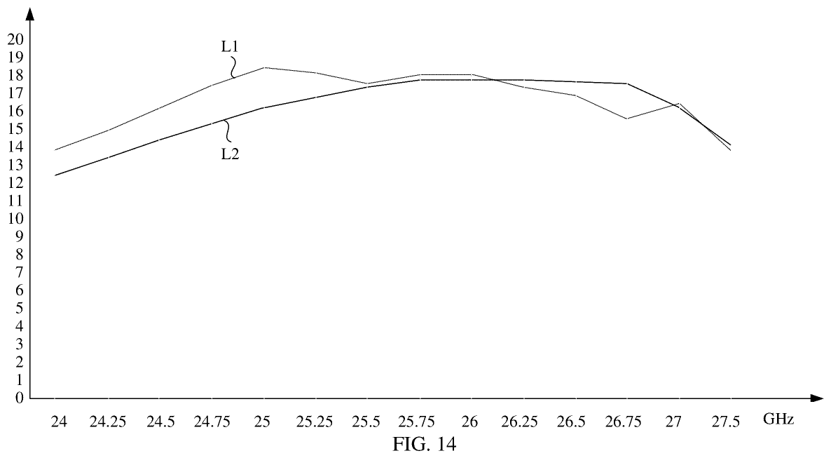

FIG. 14 shows gain curves of a TE10 mode electromagnetic signal and a TE01 mode electromagnetic signal when a sweeping periodicity length is 6p₀. As shown in FIG. 14, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is −3°, and a sweeping angle of the TE01 mode electromagnetic signal is −8°. As shown in FIG. 14, when the sweeping periodicity length is 6p₀, gains of the TE10 mode electromagnetic signal and the TE01 mode electromagnetic signal all have small differences and have good consistency. In addition, the gains are flat, and 3 dB bandwidth can reach 3 GHz.

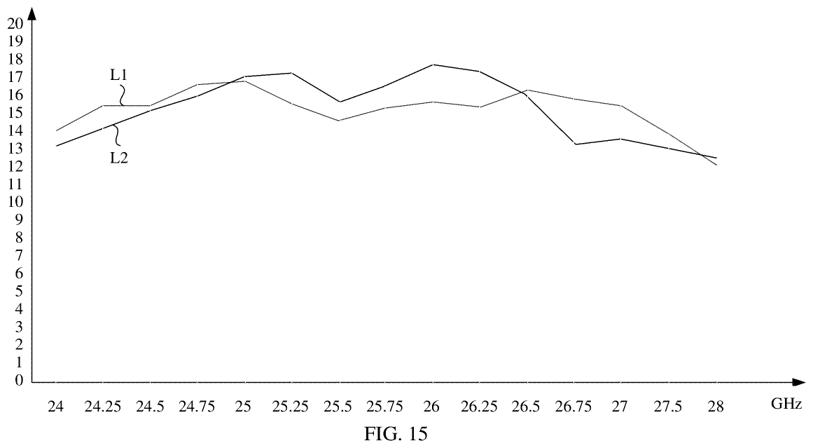

FIG. 15 shows gain curves of a TE10 mode electromagnetic signal and a TE01 mode electromagnetic signal when a sweeping periodicity length is 7p₀. As shown in FIG. 15, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is 7°, and a sweeping angle of the TE01 mode electromagnetic signal is 2°. As shown in FIG. 15, when the sweeping periodicity length is 7p₀, gains of the TE10 mode electromagnetic signal and the TE01 mode electromagnetic signal all have small differences and have good consistency. In addition, the gains are flat, and 3 dB bandwidth can reach 3 GHz.

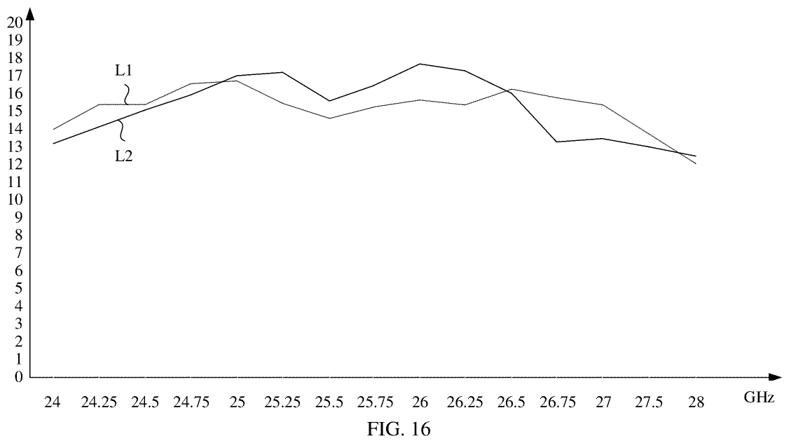

FIG. 16 shows gain curves of a TE10 mode electromagnetic signal and a TE01 mode electromagnetic signal when a sweeping periodicity length is 9p₀. As shown in FIG. 16, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is 22°, and a sweeping angle of the TE01 mode electromagnetic signal is 16°. As shown in FIG. 16, when the sweeping periodicity length is 9p₀, gains of the TE10 mode electromagnetic signal and the TE01 mode electromagnetic signal all have small differences and have good consistency. In addition, the gains are flat, and 3 dB bandwidth can reach 3 GHz.

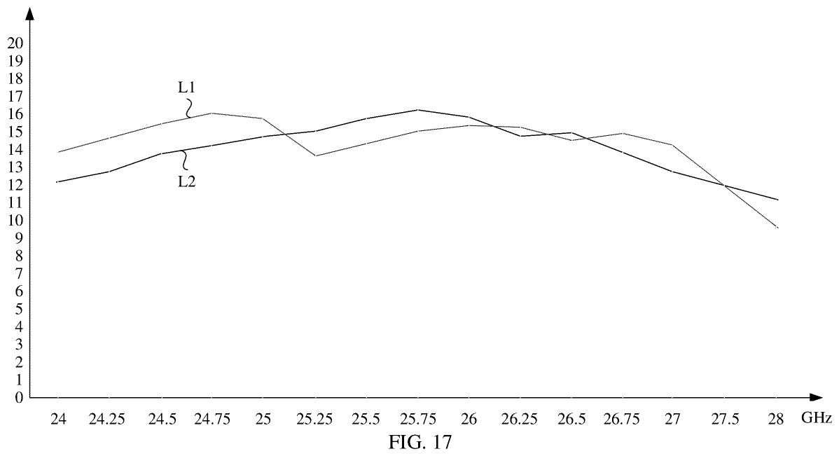

FIG. 17 shows gain curves of a TE10 mode electromagnetic signal and a TE01 mode electromagnetic signal when a sweeping periodicity length is 12p₀. As shown in FIG. 17, L1 is a gain curve of the TE10 mode electromagnetic signal, and L2 is a gain curve of the TE01 mode electromagnetic signal. A horizontal axis represents a frequency, and a vertical axis represents a gain. In this case, a sweeping angle of the TE10 mode electromagnetic signal is 36°, and a sweeping angle of the TE01 mode electromagnetic signal is 30°. As shown in FIG. 17, when the sweeping periodicity length is 12p₀, gains of the TE10 mode electromagnetic signal and the TE01 mode electromagnetic signal all have small differences and have good consistency. In addition, the gains are flat, and 3 dB bandwidth can reach 3 GHz.

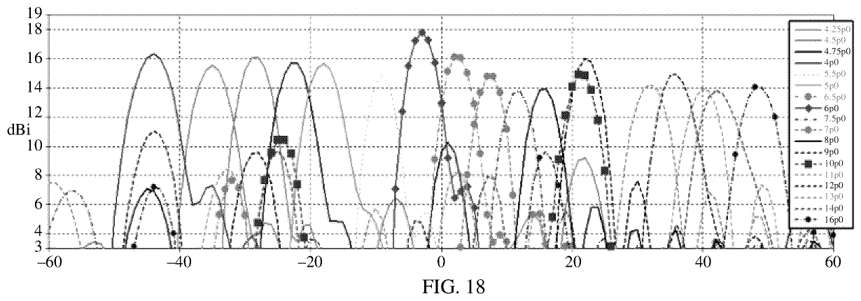

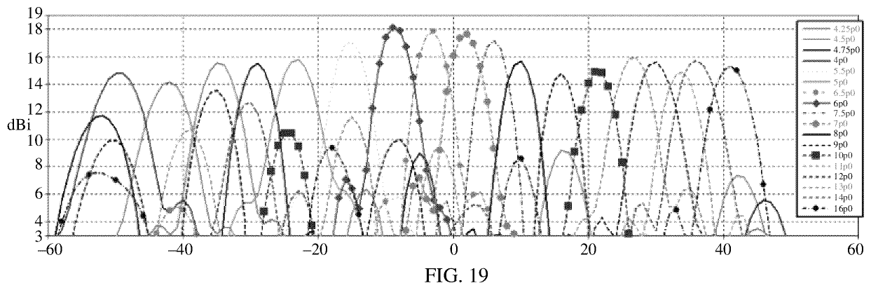

FIG. 18 shows an example of a simulation result of a perpendicular polarization radiation pattern of an antenna structure 100 according to an embodiment. FIG. 19 shows an example of a simulation result of a horizontal polarization radiation pattern of an antenna structure 100 according to an embodiment.

In FIG. 18 and FIG. 19, a selected frequency is 26 GHz, a horizontal axis represents an angle, and a vertical axis represents a gain (unit: dBi). As shown in FIG. 18, perpendicular polarization of the antenna structure 100 in embodiments can sweep an angle range from −44° to 48°, for example, a range of 92°. As shown in FIG. 19, horizontal polarization of the antenna structure 100 in embodiments can sweep an angle range from −49° to 41°, for example, a range of 90°. Both the sweeping ranges are large, which helps enrich application scenarios of the antenna structure 100.

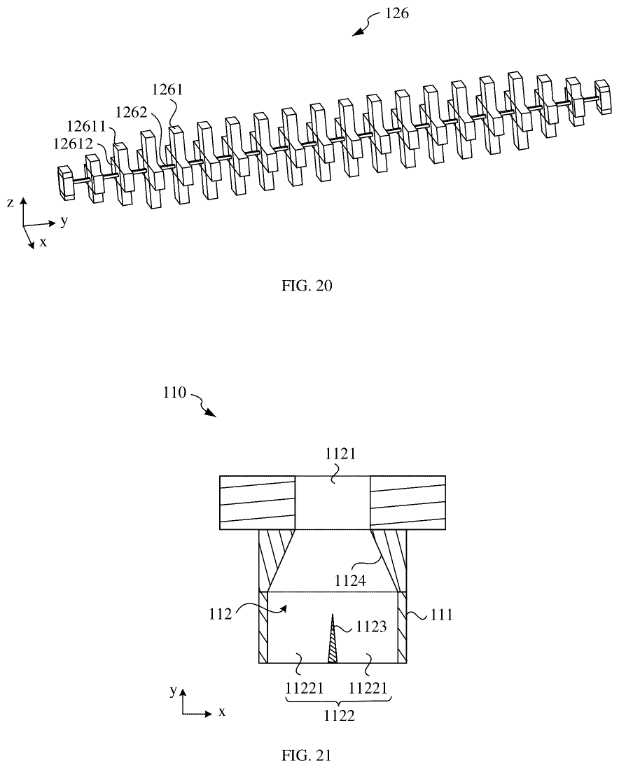

As shown in FIG. 20, a slow-wave structure 126 may be arranged in the rectangular waveguide 121. The slow-wave structure 126 is configured to convert the electromagnetic signals, fed by the feeding structure 110 into the rectangular waveguide 121, into target electromagnetic signals having a slow-wave transmission characteristic.

The slow-wave structure 126 is arranged in the rectangular waveguide 121, so that the electromagnetic signals fed into the rectangular waveguide 121 can be converted into the target electromagnetic signals having the slow-wave transmission characteristic, to improve bandwidth, the gain, power, and the like of the antenna structure 100.

In a possible embodiment, the slow-wave structure 126 includes cruciform structures 1261 and connecting segments 1262, where a plurality of cruciform structures 1261 are arranged at intervals in a perpendicular direction of a plane on which the cruciform structures 1261 are located; and the connecting segment 1262 is arranged between two adjacent cruciform structures 1261, and the connecting segment 1262 is configured to fasten the two adjacent cruciform structures 1261.

The slow-wave structure 126 is set to include the cruciform structures 1261 and the connecting segments 1262, and the cruciform structure 1261 can block the electromagnetic signals in two mutually orthogonal modes, so that the electromagnetic signals can be reflected, diffracted, or the like between the rectangular waveguide 121 and the slow-wave structure 126, and the electromagnetic signals in two mutually orthogonal modes are both converted into the target electromagnetic signals having the slow-wave transmission characteristic. The connecting segments 1262 are arranged, so that the plurality of cruciform structures 1261 can be connected. This can facilitate arrangement of the slow-wave structure 126 in the rectangular waveguide 121.

In a possible embodiment, the slow-wave structure 126 is arranged in the extension direction of the rectangular waveguide 121, and the plane on which the cruciform structures 1261 are located is perpendicular to the extension direction of the rectangular waveguide 121.

The slow-wave structure 126 is arranged in the extension direction of the rectangular waveguide 121, and the plane on which the cruciform structures 1261 are located is perpendicular to the extension direction of the rectangular waveguide 121, so that each cruciform structure 1261 on the slow-wave structure 126 can be arranged opposite to an end part of the rectangular waveguide 121. In this way, a projection area of the cruciform structure 1261 on an end surface of the rectangular waveguide 121 can be ensured to be the largest, thereby achieving a better blocking effect, improving utilization of the slow-wave structure 126, improving efficiency, and reducing a volume and costs compared with an incline arrangement.

For example, the cruciform structure 1261 may include a first extension arm 12611 and a second extension arm 12612, where the first extension arm 12611 and the second extension arm 12612 are perpendicular to each other, and a geometric center of the first extension arm 12611 coincides with a geometric center of the second extension arm 12612. In some embodiments, one of the first extension arm 12611 and the second extension arm 12612 may be perpendicular to a plane on which the radiating element 123 is located. In other words, the first extension arm 12611 of the cruciform structure 1261 is arranged in the z direction, and the second extension arm 12612 is arranged in the x direction.

The first extension arm 12611 and the second extension arm 12612 of the cruciform structure 1261 are perpendicular to each other, and the geometric center of the first extension arm 12611 coincides with the geometric center of the second extension arm 12612, so that the cruciform structure 1261 can be a centrosymmetric structure, and the slow-wave structure 126 can be a centrosymmetric structure. Because reflection of electromagnetic signals in all directions by the centrosymmetric structure in the rectangular waveguide 121 is more uniform, radiation of the antenna structure 100 in different directions can be more uniform, and the antenna performance is improved.

One of the first extension arm 12611 and the second extension arm 12612 is arranged to be perpendicular to the plane on which the radiating element 123 is located, so that the projection area of the cruciform structure 1261 on the end surface of the rectangular waveguide 121 can be the largest, thereby achieving a better blocking effect, improving utilization of the slow-wave structure 126, improving efficiency, and reducing a volume and costs compared with the incline arrangement.

In a possible embodiment, geometric centers of all the cruciform structures 1261 on the slow-wave structure 126 may be located on a same straight line. The geometric centers of all the cruciform structures 1261 on the slow-wave structure 126 are arranged on the same straight line, so that a plurality of connecting segments 1262 of the slow-wave structure 126 can be located on the same straight line. This facilitates processing of the slow-wave structure 126, thereby reducing processing costs.

In a possible embodiment, sizes of cruciform structures 1261 closer to two ends of the slow-wave structure 126 are smaller than a size of a cruciform structure 1261 closer to a middle part of the slow-wave structure 126. Sizes of the cruciform structures 1261 may gradually increase from the two ends of the slow-wave structure 126 to the middle part of the slow-wave structure 126. The plurality of cruciform structures 1261 and the connecting segments 1262 are connected to form a cross-shaped ridge structure.

Sizes of cruciform structures 1261 at the two ends of the slow-wave structure 126 are designed to be small, so that after the electromagnetic signals enter the rectangular waveguide 121, most signals can be prevented from being reflected back, and more electromagnetic signals are ensured to be transmitted inside the rectangular waveguide 121, thereby improving the gain, the power, and the like of the antenna structure 100, and improving the performance of the antenna structure 100. The slow-wave structure 126 is arranged as the cross-shaped ridge structure, so that slow-wave processing can be performed on the electromagnetic signals in two mutually orthogonal modes, and this facilitates mounting.

In embodiments, the length of the slow-wave structure 126 in the y direction is not further limited, and a total quantity of cruciform structures 1261 and a quantity of cruciform structures 1261 with small sizes and located at the ends of the slow-wave structure 126 are not further limited, provided that electromagnetic signals can be ensured to smoothly enter the rectangular waveguide 121.

As shown in FIG. 21, the feeding structure 110 on the antenna structure 100 may include a housing 111 and an inner cavity structure 112, where the inner cavity structure 112 has an input port 1121 arranged at one end and an output port 1122 arranged at the other end. The input port 1121 communicates with the output port 1122, the output port 1122 is connected to the end of the rectangular waveguide 121, and the output port 1122 communicates with the inner cavity of the rectangular waveguide 121. The output port 1122 of the feeding structure 110 communicates with the inner cavity of the rectangular waveguide 121, so that the feeding structure 110 can feed electromagnetic signals into the rectangular waveguide 121.

For example, the feeding structure 110 may be a power splitter. The power splitter may evenly allocate electromagnetic signals to different rectangular waveguides 121, so that electromagnetic energy radiated by the radiating element 123 corresponding to each rectangular waveguide 121 is balanced, thereby improving the performance of the antenna structure 100.

In some embodiments, the housing 111 of the feeding structure 110 may be of a structure including two cuboids. A cuboid closer to the input port 1121 has a larger volume than a cuboid closer to the output port 1122. Also, in another embodiment, the housing 111 of the feeding structure 110 may alternatively be in another shape. For example, the housing 111 may be of a structure including two cylinders with different outer diameters. In embodiments, a shape of the housing 111 of the feeding structure 110 is not further limited.

Still refer to FIG. 21, the feeding structure 110 further includes a retaining wall 1123, where the retaining wall 1123 is arranged in the inner cavity structure 112, and the retaining wall 1123 is located at the end that is of the inner cavity and that is closer to the output port 1122. Two ends of the retaining wall 1123 are separately connected to the housing 111, and at least one retaining wall 1123 divides the output port 1122 into a plurality of sub output ports 11221. Each sub output port 11221 corresponds to one rectangular waveguide 121, and the retaining wall 1123 is opposite to the side wall shared by the two adjacent rectangular waveguides 121.

The retaining wall 1123 is arranged, and the at least one retaining wall 1123 can divide the output port 1122 into the plurality of sub output ports 11221, so that the electromagnetic signals in two mutually orthogonal modes can be fed into the plurality of rectangular waveguides 121 by using one feeding structure 110.

In a possible embodiment, the retaining wall 1123 is a conical retaining wall 1123, and a surface that is of the retaining wall 1123 and that is closer to the input port 1121 is a small end.

The retaining wall 1123 is arranged as a conical retaining wall 1123, and the surface that is of the retaining wall 1123 and that is closer to the input port 1121 is the small end. In this way, reflection of the TE10 mode electromagnetic signal by the retaining wall 1123 can be reduced, and the TE10 mode electromagnetic signal is evenly distributed to the plurality of rectangular waveguides 121, so that the TE10 mode electromagnetic signal smoothly enters different rectangular waveguides 121, thereby improving power of the TE10 mode electromagnetic signal entering the rectangular waveguides 121, and improving the performance of the antenna structure 100.

It should be noted that, when a quantity of rectangular waveguides 121 on the leaky-wave antenna 120 is two, only one retaining wall 1123 needs to be arranged in the feeding structure 110. In addition, the retaining wall 1123 can be arranged at the end that is of the inner cavity structure 112 and that is closer to the output port 1122, and is located at a middle part of the output port 1122. The output port 1122 is divided into two sub output ports 11221, and the two sub output ports 11221 have a same size.

In a possible embodiment, still refer to FIG. 4B, a size of the sub output port 11221 may be the same as a size of the inner cavity of the rectangular waveguide 121. In this way, when the feeding structure 110 is connected to the rectangular waveguide 121, the sub output port 11221 of the feeding structure 110 may be aligned with the rectangular waveguide 121, and the retaining wall 1123 may be aligned with the side wall shared by the two adjacent rectangular waveguides 121, thereby reducing leakage of electromagnetic energy between the feeding structure 110 and the rectangular waveguide 121, increasing the power of the antenna structure 100, and improving the performance of the antenna structure 100.

Still refer to FIG. 21, sloped walls 1124 also be arranged in the inner cavity of the feeding structure 110, where two sloped walls 1124 are respectively arranged on two sides of the retaining wall 1123, and the sloped walls 1124 gradually expand outwards from the input port 1121 to the output port 1122. In this way, an included angle between the sloped walls 1124 and a cross section in the x direction of the input port 1121 is an obtuse angle.

The sloped walls 1124 are arranged in the inner cavity of the feeding structure 110, and the sloped walls 1124 gradually expand outwards from the input port 1121 to the output port 1122. In this way, after entering the feeding structure 110, the TE01 mode electromagnetic signal can smoothly enter different sub output ports 11221, and further enter different rectangular waveguides 121, thereby increasing power of the TE01 mode electromagnetic signal entering the rectangular waveguides 121, and improving the performance of the antenna structure 100.

For example, specific spacing exists between an end that is of the sloped wall 1124 and that is closer to the retaining wall 1123 and an end that is of the retaining wall 1123 and that is closer to the input port 1121, so as to ensure that no mutual interference is generated between the TE10 mode electromagnetic signal and the TE01 mode electromagnetic signal, and ensure that a proportion of electromagnetic signals entering the rectangular waveguide 121 is high, thereby improving the performance of the antenna structure 100.

In embodiments, a specific size of the feeding structure 110 is not further limited.

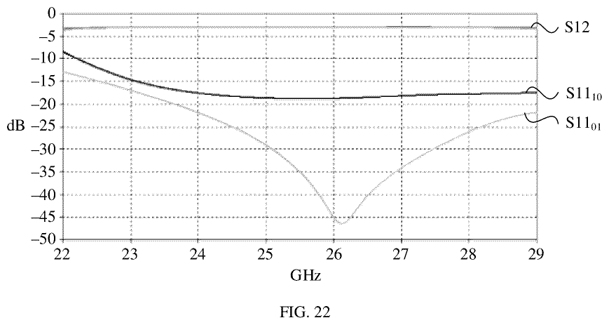

FIG. 22 is an S-parameter diagram of the feeding structure 110 of the antenna structure 100 according to an embodiment. As shown in FIG. 22, a horizontal axis represents a frequency in a unit of GHz; and a vertical axis represents an amplitude value of an S parameter in a unit of dB. S11₁₀ in the figure represents a reflection coefficient of the TE10 mode electromagnetic signal at the input port 1121, and may also be understood as an energy value of an electromagnetic signal output from the input port 1121 by inputting the TE10 mode electromagnetic signal into the input port 1121. S11₀₁ represents a reflection coefficient of the TE01 mode electromagnetic signal at the input port 1121, and may also be understood as an energy value of an electromagnetic signal output from the input port 1121 by inputting the TE01 mode electromagnetic signal into the input port 1121. S12 represents a transmission coefficient of the TE10 mode electromagnetic signal and the TE01 mode electromagnetic signal from the input port 1121 to the output port 1122, such as, an energy value of an electromagnetic signal received from one of the sub output ports 11221 by inputting the TE10 mode electromagnetic signal and the TE01 mode electromagnetic signal into the input port 1121.

It should be noted that S12 includes a plurality of mutually overlapping curves that respectively represent electromagnetic signals in different modes. For example, S12 may include an energy value of an electromagnetic signal received from a left-side sub output port 11221 in the figure by inputting the TE10 mode electromagnetic signal into the input port 1121; S12 may include an energy value of an electromagnetic signal received from a right-side sub output port 11221 in the figure by inputting the TE10 mode electromagnetic signal into the input port 1121; S12 may include an energy value of an electromagnetic signal received from the left-side sub output port 11221 in the figure by inputting the TE01 mode electromagnetic signal into the input port 1121; and S12 may include an energy value of an electromagnetic signal received from the right-side sub output port 11221 in the figure by inputting the TE01 mode electromagnetic signal into the input port 1121. These curves overlap each other, and therefore, are placed on the same curve.

As shown in FIG. 22, in this embodiment, it can be understood from the curves S11₁₀ and S11₀₁ that, when an operating frequency is 24 GHz to 29 GHz, energy of electromagnetic signals reflected from the input port 1121 after the electromagnetic signals in the two modes enter the input port 1121 is less than −10 dB, or even less than −18 dB. Therefore, it may be noted that return losses of the electromagnetic signals in the two modes fed into the input port 1121 of the feeding structure 110 are small. In other words, most energy can enter the inside of the feeding structure 110 from the input port 1121, to enter the output port 1122.

It can be understood from the curve S12 that, when the operating frequency is 24 GHz to 29 GHz, after the electromagnetic signals in the two modes enter the input port 1121, energy at two sub input ports 1121 is close to −3 dB. Therefore, it may be noted that most energy of the electromagnetic signals in the two modes fed into the input port 1121 of the feeding structure 110 enters the sub output ports 11221. In addition, curves of the two modes overlap, which indicates that power values of the electromagnetic signals entering the two rectangular waveguides 121 through the feeding structure 110 are basically the same. It can be understood that the feeding structure 110 is applicable to both the TE10 mode electromagnetic signal and the TE01 mode electromagnetic signal, and both the two modes can implement good equal power allocation and low loss transmission at 24 GHz to 29 GHz.

Further, a size of the antenna structure may be another size, and the operating frequency of the antenna structure may also be in another band. An operation band of the antenna structure may be implemented by changing the size of the antenna structure. For example, a size of the rectangular waveguide may be increased, and the length of the slow-wave structure in the y direction may be appropriately increased, so that the antenna structure can operate in a low frequency field.

The antenna structure provided in embodiments may be applied to fields such as satellite communication, unmanned aerial vehicle, unmanned vehicle, 5G mobile communication, 5G base station, and intelligent logistics. In addition, a dual-polarized antenna structure may generate two mutually orthogonal polarized waves, and two signals are orthogonal to each other and therefore do not affect each other. In this way, one antenna structure can be arranged in a duplex operating mode of receiving and transmitting, to reuse the antenna structure, thereby improving a communication capacity and reducing a quantity of antenna structures mounted in a base station. In addition, the antenna structure provided in embodiments may at least have advantages of implementing fixed-frequency beam sweeping, having a strong anti-interference capability, and improving a channel capacity.

It should be understood that, in the embodiments, “electrically connected” may be understood as physical contact and electrical conduction of components, or may be understood as a form in which different components in a line structure are connected through physical lines that can transmit an electrical signal, such as a printed circuit board (PCB) copper foil or a conducting wire. “Fixedly and electrically connected” may be understood as that components are physically fastened and can be electrically conductive.

In the description of embodiments, it should be noted that unless otherwise specified and limited, the terms “mounting”, “connection”, and “connecting” may all refer to a mechanical connection relationship or a physical connection relationship, for example, may be a fixed connection, or may be an indirect connection via an intermediate medium, or may be communication inside two components or an interaction relationship between two components. A person of ordinary skill in the art may understand specific meanings of the foregoing terms in embodiments based on specific cases. For example, a connection between A and B or A is connected to B refers to that there is a fastening member (such as a screw, a bolt, or a rivet) between A and B, or A and B contact each other and it is difficult to separate A and B. Opposite/Arranged opposite to each other: A and B are arranged opposite to each other may refer to that A is arranged opposite to or face to face to B (opposite to or face to face).

In the embodiments and foregoing accompanying drawings, the terms “first”, “second”, “third”, “fourth”, and the like (if existent) are intended to distinguish between similar objects but do not necessarily indicate a specific order or sequence.

It should be understood that the embodiments herein are some, rather than all, of the embodiments. Further, any changes or modifications made by persons of ordinary skill in the art shall fall within the scope of the embodiments herein.

1. An antenna structure, comprising:
a feeding structure; and
a leaky-wave antenna, wherein
the leaky-wave antenna comprises a rectangular waveguide and a radiating element, and the radiating element is located on any side wall of the rectangular waveguide;
the radiating element comprises slot elements, and a plurality of groups of slot elements are arranged at intervals in an extension direction of the rectangular waveguide;
the slot element comprises a first slot and a second slot, the first slot and the second slot are arranged with an included angle, and the first slot and the second slot are arranged at intervals in the extension direction of the rectangular waveguide;
the leaky-wave antenna further comprises a control component, the control component is connected to the radiating element, and the control component is configured to control the first slot and the second slot to be open-circuited or short-circuited; and
the feeding structure is arranged at an end of the rectangular waveguide, and the feeding structure is configured to feed electromagnetic signals in two mutually orthogonal modes into the rectangular waveguide.

2. The antenna structure according to claim 1, wherein the first slot and the second slot are perpendicular to each other.

3. The antenna structure according to claim 1, wherein one of the first slot and the second slot is arranged in the extension direction of the rectangular waveguide; and
the other one of the first slot and the second slot is arranged perpendicular to the extension direction of the rectangular waveguide.

4. The antenna structure according to claim 1, wherein a slow-wave structure is arranged in the rectangular waveguide, wherein
the slow-wave structure is configured to convert the electromagnetic signals, fed by the feeding structure into the rectangular waveguide, into target electromagnetic signals having a slow-wave transmission characteristic.

5. The antenna structure according to claim 4, wherein the slow-wave structure comprises cruciform structures and connecting segments, wherein
a plurality of cruciform structures are arranged at intervals in a perpendicular direction of a plane on which the cruciform structures are located; and
the connecting segment is arranged between two adjacent cruciform structures, and the connecting segment is configured to fasten the two adjacent cruciform structures.

6. The antenna structure according to claim 5, wherein the slow-wave structure is arranged in the extension direction of the rectangular waveguide; and
the plane on which the cruciform structures are located is perpendicular to the extension direction of the rectangular waveguide.

7. The antenna structure according to claim 5, wherein the cruciform structure comprises a first extension arm and a second extension arm, wherein
the first extension arm and the second extension arm are perpendicular to each other, and a geometric center of the first extension arm coincides with a geometric center of the second extension arm.

8. The antenna structure according to claim 7, wherein one of the first extension arm and the second extension arm is perpendicular to a plane on which the radiating element is located.

9. The antenna structure according to claim 5, wherein geometric centers of all the cruciform structures on the slow-wave structure are located on a same straight line.

10. The antenna structure according to claim 5, wherein sizes of the cruciform structures closer to two ends of the slow-wave structure are smaller than a size of the cruciform structure closer to a middle part of the slow-wave structure.

11. The antenna structure according to claim 10, wherein sizes of the cruciform structures gradually increase from the two ends of the slow-wave structure to the middle part of the slow-wave structure.

12. The antenna structure according to claim 1, wherein the leaky-wave antenna comprises a circuit board, wherein
the circuit board is one side wall of the rectangular waveguide, and the radiating element is arranged on the circuit board.

13. The antenna structure according to claim 12, wherein the circuit board comprises a first dielectric layer and a metal layer, wherein
the first dielectric layer and the metal layer are arranged in a stacked manner, one surface of the first dielectric layer faces an inner cavity of the rectangular waveguide, and the other surface of the first dielectric layer is connected to the metal layer; and
the radiating element is arranged on the metal layer.

14. The antenna structure according to claim 13, wherein the leaky-wave antenna further comprises a primary radiation structure, wherein
the primary radiation structure and the metal layer are arranged in a stacked manner, and the radiation structure is located on a surface that is of the metal layer and that is away from the first dielectric layer.

15. The antenna structure according to claim 14, wherein the primary radiation structure comprises a plurality of metal patches, wherein
each group of slot elements corresponds to one metal patch.

16. The antenna structure according to claim 15, wherein the circuit board further comprises a second dielectric layer, wherein
the second dielectric layer is located on the surface that is of the metal layer and that is away from the first dielectric layer, and the primary radiation structure is located on a surface that is of the second dielectric layer and that is away from the metal layer.

17. The antenna structure according to claim 1, wherein the control component comprises a plurality of first switches and a plurality of second switches, wherein
the plurality of first switches are configured to control a plurality of first slots to be open-circuited or short-circuited; and
the plurality of second switches are configured to control a plurality of second slots to be open-circuited or short-circuited.

18. The antenna structure according to claim 17, further comprising a control unit, the control unit is connected to the control component, and the control unit is configured to control the plurality of first switches and the plurality of second switches in the control component to be turned on or turned off.

19. The antenna structure according to claim 1, wherein the leaky-wave antenna comprises a plurality of rectangular waveguides, wherein
the plurality of rectangular waveguides are arranged in parallel in an extension direction perpendicular to the rectangular waveguides, and two adjacent rectangular waveguides share one side wall; and
one radiating element is arranged on each rectangular waveguide, each radiating element is perpendicular to the side wall shared by the two adjacent rectangular waveguides, and radiating elements on different rectangular waveguides are all located on a same surface of the leaky-wave antenna.

20. The antenna structure according to claim 19, wherein the slot elements on two adjacent radiating elements are arranged in an interlaced manner.
